(19) United States
(12) Patent Application Publication
(10) Pub. No.: US 2026/0034417 A1
(43) Pub. Date: Feb. 5, 2026

(54) PICKLEBALL PADDLE AND METHOD OF RECYCLING PICKLEBALL PADDLE

(71) Applicant: SSHENG APPLIED R-MATERIALS CO., LTD., TAICHUNG CITY (TW)

(72) Inventor: Wei-Lun HO, TAICHUNG CITY (TW)

(21) Appl. No.: 19/067,401

(22) Filed: Feb. 28, 2025

(30) Foreign Application Priority Data
Aug. 2, 2024 (TW) 113128982

(51) Int. Cl. A63B 59/42; A63B 60/08; A63B 60/14; A63B 102/08; B29B 17/04; B29K 23/00; B29L 31/52; B32B 3/12; B32B 5/02; B32B 7/12; B32B 27/32

(52) U.S. Cl. CPC A63B 59/42; A63B 60/08; A63B 60/14; B32B 3/12; B32B 5/024; B32B 7/12; B32B 27/32; A63B 2102/08; A63B 2209/02; B29B 17/0412; B29B 2017/0468; B29K 2023/12; B29L 2031/5245

(57) ABSTRACT

A pickleball paddle includes a first padding, two second paddings, an edge strip, and a grip. The first padding is a honeycomb structure made of polypropylene. The second paddings are bonded to two opposite surfaces of the first padding, and the second paddings each have a polypropylene layer and a fiber fabric bonded to the polypropylene layer. The edge strip is connected to the edge of the first padding and the edges of the second paddings, and the edge strip is made of a material including polypropylene. The grip is connected to the edge strip, and the grip is made of a material including polypropylene. Thus, the pickleball paddle of the present invention is easy to recycle and can reduce harm to the environment. Additionally, the present invention further includes a method of recycling the aforesaid pickleball paddle.

### BACKGROUND OF THE INVENTION

### 1. Field of the Invention

The present invention relates to pickleball paddles and more particularly, to a pickleball paddle that is easy to recycle, and a method of recycling the pickleball paddle.

### 2. Description of the Related Art

CN 220632943 discloses that a multi-layer composite pickleball paddle includes a core material with a honeycomb structure, two second padding structures, a third padding structure, and a third surface layer structure. The core material has two opposite hitting surfaces. The second padding structures are respectively bonded onto the two hitting surfaces of the core material. The third padding structures are respectively bonded onto the second padding structures. The third surface layer structures are respectively bonded onto the third padding structures.

However, the second padding structure is made of carbon fiber and epoxy resin composite material, the third padding structure is made of aramid fiber and epoxy resin composite material, and the third surface layer structure is made of hemp fiber and epoxy resin composite material. Since the first, second, and third surface layer structures all contain epoxy resin, which is difficult to recycle, when the damaged multi-layer composite pickleball paddle needs to be destroyed, it often can only be treated by burial or incineration, which can easily cause negative environmental impacts. Therefore, providing a pickleball paddle that is easy to recycle and can reduce harm to the environment is an issue that businesses currently need to face urgently.

### SUMMARY OF THE INVENTION

It is one objective of the present invention to provide a pickleball paddle, which is easy to recycle and can reduce harm to the environment.

To attain the above objective, the pickleball paddle of the present invention comprises a first padding, two second paddings, an edge strip, and a grip. The first padding, which is a honeycomb structure made of polypropylene, has a first surface and a second surface opposite to the first surface. The second paddings are bonded to the first and second surfaces of the first padding, and the second paddings each have a polypropylene layer and a fiber fabric bonded to the polypropylene layer. The edge strip is connected to an edge of the first padding and edges of the second paddings, and the edge strip is made of a material including polypropylene. The grip is connected to the edge strip, and the grip is made of a material including polypropylene.

It can be seen from the above that since each component of the pickleball paddle of the present invention is made of easily recyclable polypropylene, the pickleball paddle of the present invention can be directly crushed and recycled to be remanufactured into other items. Compared to prior art that use burial or incineration methods, the pickleball paddle of the present invention has a smaller environmental impact during the recycling process, thereby reducing the harm to the environment.

Preferably, the fiber fabric is made of a material selected from a group consisting of carbon fiber, glass fiber, hemp fiber, flax fiber, aramid fiber, and basalt fiber. In this way, the second padding has characteristics of being lighter in weight, stronger in strength, and better in toughness, making the effect of rebounding a pickleball more pronounced, thereby increasing the user's sensitivity during hitting.

Preferably, the edge strip is made of a modified polypropylene elastomer, so that the edge strip has better elasticity and toughness to provide good coverage.

Preferably, the first padding has a first grip portion sandwiched between two second grip portions of the second paddings. Two grip members are attached to the outer surfaces of the second grip portions of the second paddings and connected to the edge strip, so that a grip is formed by the first grip portion, the two second grip portions, and the two grip members. The grip members are made of expanded polypropylene, so that the grip members can provide the user with better hold, increasing the comfort of the grip.

Preferably, the grip members are indirectly connected to the edge strip through a ring that is bonded to a junction of the grip and the edge strip. The ring is made of a modified polypropylene elastomer. In this way, the ring has better elasticity and toughness to increase the structural strength between the grip and the edge strip.

Preferably, the grip members are fixed to the outer surfaces of the second grip portions of the second paddings through a fastening cover that is bonded to a distal end of the grip. The fastening cover is made of polypropylene. In this way, the fastening cover has better toughness to increase the structural strength of the grip.

Preferably, a grip tape is wrapped around the grip and the fastening cover, and the grip tape is made of a modified polypropylene elastomer. In this way, the grip tape can increase the friction of the grip to provide a non-slip effect, and further, the grip tape has better elasticity and toughness to increase the structural strength of the grip.

Preferably, the edge strip is connected to the edge of the first padding and the edges of the second paddings through an adhesive that is made of a modified polypropylene hot melt adhesive.

Preferably, two third paddings are bonded to the second paddings, and edges of the third paddings are connected with the edge strip. The third paddings are made of polypropylene. In this way, the third padding can be printed with different patterns and colors to enhance the overall aesthetics. Moreover, the third padding has better strength and toughness to protect the second padding.

Preferably, the edge strip is connected to the edge of the first padding, the edges of the second paddings, and the edges of the third paddings through an adhesive that is made of a modified polypropylene hot melt adhesive. In this way, the edge strip can be firmly attached to the edges of the first, second, and third paddings through the adhesive.

It is another objective of the present invention to provide a method of recycling the pickleball paddle, which is easy to operate.

To attain the above objective, the pickleball paddle of the present invention comprises following steps: a) crushing the pickleball paddle to form multiple fragments; and b) recycling the fragments and remanufacturing the fragments into an item.

Preferably, in the step a), the pickleball paddle is crushed into the fragments by using a shredder. In the step b), the fragments are heated through an injection molding machine to form a molten body, and the injection molding machine extrudes the molten gel into a mold to produce the item.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of a pickleball paddle of a first embodiment of the present invention.

FIG. 2 is an exploded view of the pickleball paddle of the first embodiment of the present invention.

FIG. 3 is a sectional view of the pickleball paddle of the first embodiment of the present invention.

FIG. 4 is an exploded view of the pickleball paddle of a second embodiment of the present invention.

FIG. 5 is a flow chart of a method of recycling the pickleball paddle of the present invention.

### DETAILED DESCRIPTION OF THE INVENTION

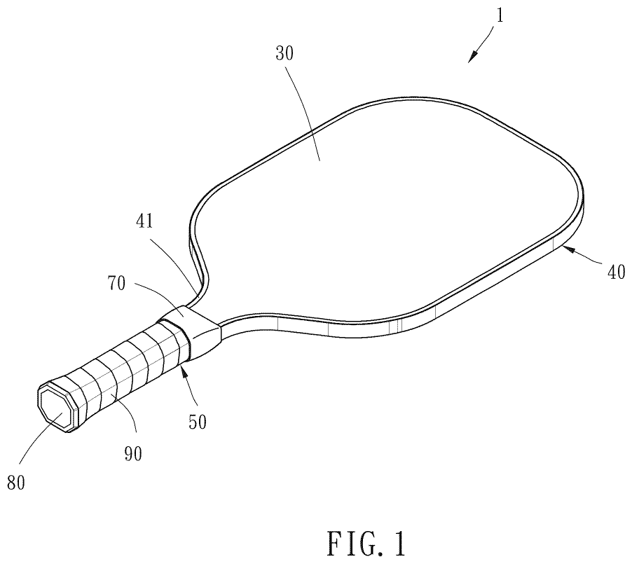

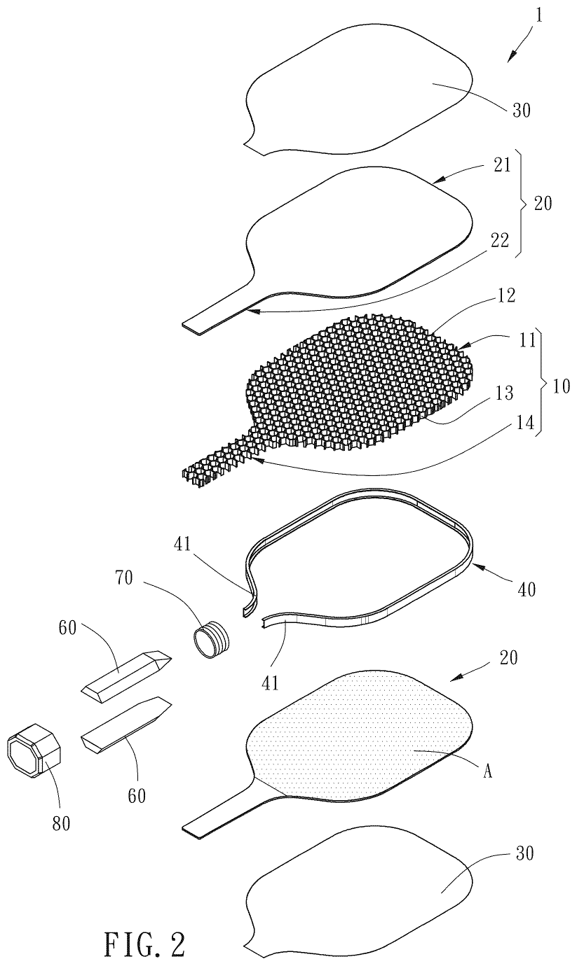

Referring to FIGS. 1 and 2, a pickleball paddle 1 of the first embodiment of the present invention comprises a first padding 10, two second paddings 20, two third paddings 30, an edge strip 40, and a grip 50.

As shown in FIG. 2, the first padding 10 is a honeycomb structure, so that the first padding 10 can maintain a certain structural strength and reduce the overall weight. The first padding 10 includes a first body 11 provided with a first surface 12 and a second surface 13 opposite to the first surface 12, and a first grip portion 14 extending from the first body 11. The first padding 10 is made of polypropylene (PP), so that the first padding has higher impact resistance. When a pickleball (not shown) impacts the first and second surfaces 12, 13 of the first padding 10, the first padding 10 can uniformly absorb and release the impact of the pickleball.

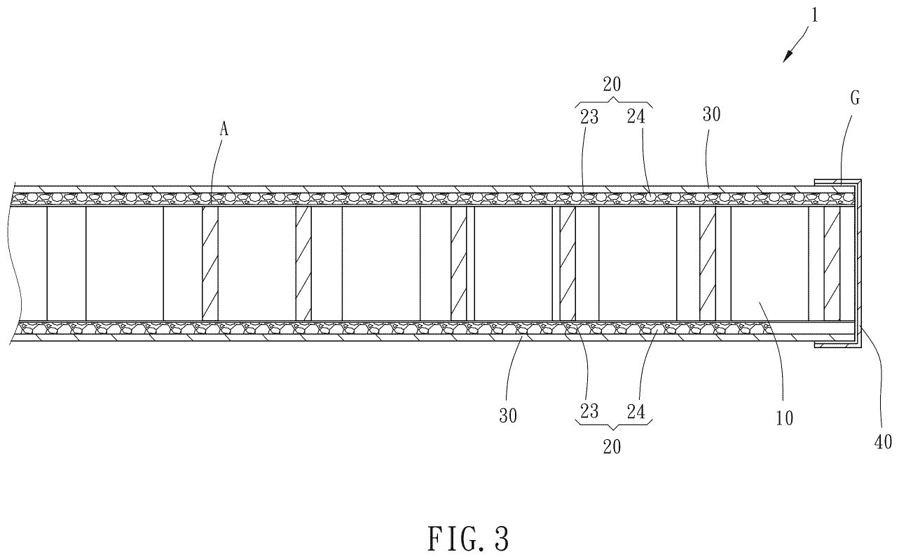

As shown in FIGS. 2 and 3, the second paddings 20 each have a second body 21, a second grip portion 22 extending from the second body 21, and an adhesive layer A covering the second body 21. The adhesive layer A is a self-adhesive double-sided tape or a hot melt adhesive. When assembled, the second bodies 21 of the second paddings 20 are respectively bonded to the first and second surfaces 12, 13 of the first padding 10 through the adhesive layers A.

As shown in FIG. 3, the second paddings 20 each have a polypropylene layer 23 and a fiber fabric 24 bonded to the polypropylene layer 23. The fiber fabric 24 is made of a material selected from a group consisting of carbon fiber, glass fiber, hemp fiber, flax fiber, aramid fiber, and basalt fiber, and the fiber fabric 24 is woven from the selected fiber. During the manufacturing process, the fiber fabric 24 is soaked in a polypropylene gel, allowing the polypropylene gel to permeate into the fiber fabric 24. The polypropylene gel then cures to form the polypropylene layer 23. As a result, the second padding 20 exhibits characteristics of being lightweight, strong, and having improved toughness. This allows the second padding 20 to exhibit a more significant rebound effect for the pickleball. In other words, when the pickleball makes contact with the second padding 20, it quickly rebounds to increase the user's batting sensitivity.

In this embodiment, the third padding 30 can be combined with the second padding 20 in two ways. The first way involves the third padding 30 being attached to the second padding 20 by using a self-adhesive double-sided tape, or the third padding 30 being coated with a hot melt adhesive and bonded to the second padding 20 through the hot melt adhesive. The second way involves directly spraying, printing, or transferring ink onto the outer surface of the second padding 20, causing the ink to form the third padding 30. Since the third padding 30 has different patterns and colors, it not only enhances the overall aesthetic appeal but also creates varying surface roughness through the patterns. This results in different frictional forces when the third padding 30 contacts the pickleball, causing the pickleball to generate varying degrees of spin. Additionally, since the third padding 30 is also made of polypropylene (PP), the third padding 30 has the same material properties as the first padding 10 and the second padding 20.

As shown in FIGS. 1-3, the end strip 40 is bonded to the edge of the first padding 10, the edges of the second paddings 20, and the edges of the third paddings 30 through an adhesive G for providing protection. The adhesive G is made of a modified polypropylene hot melt adhesive, so that the edge strip 40 can be firmly attached to the edge of the first padding 10, the edges of the second paddings 20, and the edges of the third paddings 30 through the adhesive G. Additionally, the end strip 40 is made of a modified polypropylene elastomer. The elastomer can be, but not limited to, polyethylene (PE), ethylene propylene diene monomer (EDPM), styrene butadiene styrene block copolymer (SBS), styrene-ethylene-butylene-styrene block copolymer (SEBS), styrene-ethylene/ethylene-propylene-styrene triblock copolymer (SEEPS), and thermoplastic olefin (TPO), or thermoplastic polyurethane (TPU). Therefore, the edge strip 40 has superior elasticity and toughness to provide excellent coverage.

As shown in FIG. 2, in this embodiment, the pickleball paddle 1 further comprises two grip members 60 are attached to the outer surfaces of the second grip portions 22 of the second paddings 20, so that a grip 50 as shown in FIG. 1 is formed by the first grip portion 14 of the first padding 10, the two second grip portions 22 of the second paddings 20, and the two grip members 60. The grip member 60 is made of expanded polypropylene (EPP), so that the grip member 60 provides the user with better grip and a lightweight feature, enhancing the comfort when the user holds the grip 50.

Furthermore, as shown in FIGS. 1-2, the pickleball paddle 1 further comprises a ring 70 and a fastening cover 80. The ring 70 is bonded to a junction of the front end of the grip 50 and two end portions 41 of the edge strip 40, so that the grip members 60 are indirectly connected to the end strip 40 through the ring 70. The ring 70 is made of a modified polypropylene elastomer, so that the ring 70 has better elasticity and toughness to increase the structural strength between the grip 50 and the edge strip 40. Next, the fastening cover 80 is bonded to the distal end of the grip 50, so that the grip members 60 are fixe to the outer surfaces of the second grip portions 22 of the second paddings 20 through the fastening cover 80. The fastening cover 80 is made of polypropylene, so that the fastening cover 80 has better toughness to increase the structural strength of the grip 50.

In addition, as shown in FIG. 1, the pickleball paddle 1 further comprises a grip tape 90. The grip tape 90 is wrapped around the outer surface of the grip 50 and the outer surface of the fastening cover 80 to increase the friction of the grip 50 and provide a non-slip effect. The grip tape 90 is made of a modified polypropylene elastomer, so that the grip tape 90 has better elasticity and toughness to increase the structural strength of the grip 50.

What needs to be supplemented here is that in other embodiment, the grip members 60 can also be fixed to the second grip portions 22 by using other methods (such as adhesive, fasteners, or stitching) without the need for the ring 70, the fastening cover 80, and the grip tape 90. Therefore, the ring 70, the fastening cover 80, and the grip tape 90 are optional components.

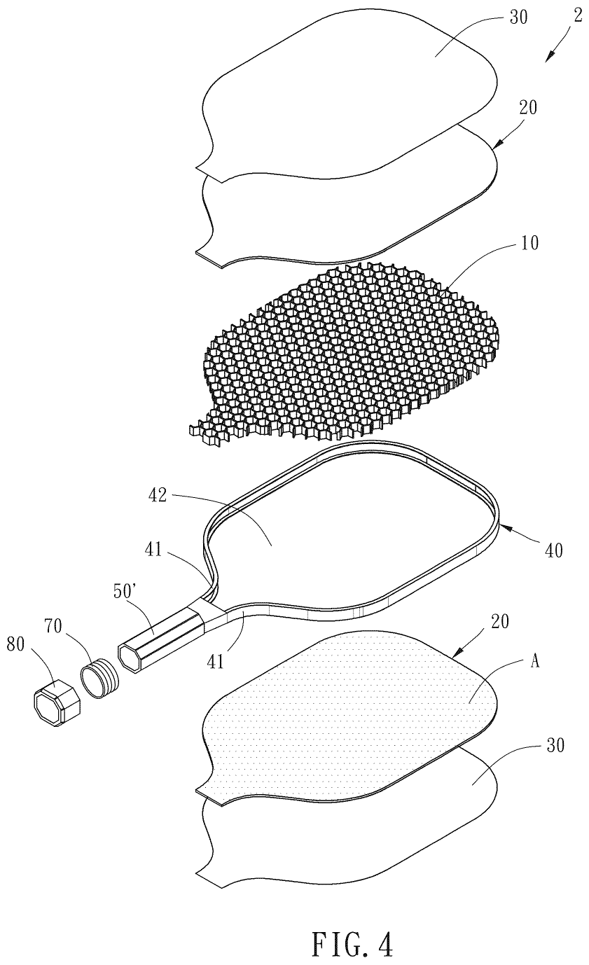

Please refer to FIG. 4, the main structure of the pickleball paddle 2 of the second embodiment is approximately the same with the first embodiment, but one of the differences therebetween is that this embodiment provides another grip 50′. The grip 50′ is made of expanded polypropylene (EPP) to provide the user with better grip. In this embodiment, the grip 50′ is an integrally formed structure and can be made in either a solid or hollow configuration. Further, the grip 50′ is directly connected to the two end portions 41 of the edge strip 40, forming a closed space 42 surrounded by the edge strip 40. The first padding 10, the second paddings 20, and the third paddings 30 are assembled in the same sequence as the first embodiment and placed within the space 42. The assembly method of the ring 70, the fastening cover 80, and the grip tape 90 (as shown in FIG. 1) is identical to that of the first embodiment, so it will not be repeated here.

The above is the structure of the pickleball paddle 1, 2 of the present invention, and a method of recycling the pickleball paddle 1, 2 of the present invention is further introduced below.

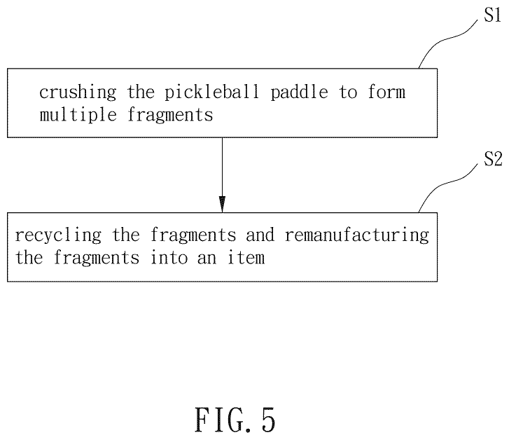

Please refer to FIG. 5, the method of recycling the pickleball paddle 1, 2 of the present invention comprises following steps:

Step S1: crushing the pickleball paddle 1, 2 to form multiple fragments.

In this step, since all the components of the pickleball paddle 1, 2 of the present invention are made of polypropylene (PP), there is no need to separate each component. The pickleball paddle 1, 2 can simply be placed into a shredder to be crushed into fragments, facilitating the subsequent recycling process.

Step S2: recycling the fragments and remanufacturing the fragments into an item.

In this step, the fragments are heated through an injection molding machine (not shown) to form a molten body. Next, the injection molding machine extrudes the molten gel into a mold until the molten gel inside the mold cools and hardens to form an item. Once the item is formed, it can be removed from the mold. It should be added here that the item can be (but are not limited to) plastic bottles, toys, spectacle frames or food packaging, etc.

As indicated above, since each component of the pickleball paddle 1, 2 of the present invention is made of easily recyclable polypropylene (PP), the pickleball paddle 1, 2 of the present invention can be directly crushed and recycled to be remanufactured into other items. Compared to prior art that use burial or incineration methods, the pickleball paddle 1, 2 of the present invention has a smaller environmental impact during the recycling process, thereby reducing the harm to the environment.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A pickleball paddle comprising:
a first padding having a first surface and a second surface opposite to the first surface, the first padding being a honeycomb structure made of polypropylene;
two second paddings bonded to the first and second surfaces of the first padding and each having a polypropylene layer and a fiber fabric bonded to the polypropylene layer;
an edge strip connected to an edge of the first padding and edges of the second paddings and made of a material including polypropylene; and
a grip connected to the edge strip and made of a material including polypropylene.

2. The pickleball paddle as claimed in claim 1, wherein the fiber fabric is made of a material selected from a group consisting of carbon fiber, glass fiber, hemp fiber, flax fiber, aramid fiber, and basalt fiber.

3. The pickleball paddle as claimed in claim 1, wherein the edge strip is made of a modified polypropylene elastomer.

4. The pickleball paddle as claimed in claim 1, wherein the first padding has a first grip portion sandwiched between two second grip portions of the second paddings; two grip members are fixed to outer surfaces of the second grip portions of the second paddings and connected to the edge strip, so that a grip is formed by the first grip portion, the two second grip portions, and the two grip members, and the grip members are made of expanded polypropylene.

5. The pickleball paddle as claimed in claim 4, wherein the grip members are indirectly connected to the edge strip through a ring bonded to a junction of the grip and the edge strip, and the ring is made of a modified polypropylene elastomer.

6. The pickleball paddle as claimed in claim 4, wherein the grip members are fixed to the outer surfaces of the second grip portions of the second paddings through a fastening cover bonded to a distal end of the grip, and the fastening cover is made of polypropylene.

7. The pickleball paddle as claimed in claim 1, wherein the grip is directly connected to the edge strip, and the grip is made of expanded polypropylene.

8. The pickleball paddle as claimed in claim 7, wherein a ring is bonded to a junction of the grip and the edge strip, and the ring is made of a modified polypropylene elastomer.

9. The pickleball paddle as claimed in claim 7, wherein a fastening cover is bonded to a distal end of the grip, and the fastening cover is made of polypropylene.

10. The pickleball paddle as claimed in claim 6, wherein a grip tape is wrapped around the grip and the fastening cover, and the grip tape is made of a modified polypropylene elastomer.

11. The pickleball paddle as claimed in claim 1, wherein the edge strip is connected to the edge of the first padding and the edges of the second paddings through an adhesive made of a modified polypropylene hot melt adhesive.

12. The pickleball paddle as claimed in claim 1, further comprising two third paddings made of polypropylene and bonded to the second paddings; the edge strip is connected to edges of the third paddings.

13. The pickleball paddle as claimed in claim 12, wherein the edge strip is connected to the edge of the first padding, the edges of the second paddings, and the edges of the third paddings through an adhesive made of a modified polypropylene hot melt adhesive.

14. A method of recycling the pickleball paddle as claimed in claim 1, comprising steps of:
a) crushing the pickleball paddle to form multiple fragments; and
b) recycling the fragments and remanufacturing the fragments into an item.

15. The method as claimed in claim 14, wherein in the step a), the pickleball paddle is crushed into the fragments by using a shredder; in the step b), the fragments are heated through an injection molding machine to form a molten body, and the injection molding machine extrudes the molten gel into a mold to produce the item.
